(19) United States
(12) Patent Application Publication
(10) Pub. No.: US 2011/0131460 A1
(43) Pub. Date: Jun. 2, 2011

(54) METHOD FOR REPAIRING IMAGE

(75) Inventors: Fan-Chieh Cheng, Keelung City (TW); Shih-Chia Huang, Taipei City (TW); Sy-Yen Kuo, Taipei (TW)

(73) Assignee: ACER INCORPORATED, Taipei Hsien (TW)

(21) Appl. No.: 12/947,075

(22) Filed: Nov. 16, 2010

(30) Foreign Application Priority Data
Dec. 2, 2009 (TW) 98141141

(51) Int. Cl. G06F 11/07

(52) U.S. Cl. 714/746; 714/E11.023

(57) ABSTRACT

A method for repairing an image is disclosed. To repair an image, the method first applies a statistic method based on a plurality of reference data to generate a predicted value range. Then repairing data having values in the predicted value range is generated to repair the image. The reference data of low correlation is filtered out to enhance the quality of a repaired image.

### CROSS REFERENCE TO RELATED APPLICATIONS

This application claims priority to Taiwan Application No. 98141141 entitled “Method for Repairing Image” filed on Dec. 2, 2009, which application is incorporated herein by reference.

### BACKGROUND OF THE INVENTION

1. Technical Field

The present invention relates to image processing methods, and more particularly, to an error-containing image repairing method.

2. Description of Related Art

An image or a video comprising a plurality of images incurs errors when subjected to a packet loss or a bit error while being transmitted by a network. Frequently seen image repairing methods, also known as error concealment methods, are of three types, namely a spatial error concealment method, a temporal error concealment method, and a mixed error concealment method.

A spatial error concealment method involves sampling information of a correct block adjacent to an error block in an image so as to repair the error block. In an image, there is likely a high correlation between an error pixel and pixels adjacent thereto in terms of image contents, for example, sharing part of the sky, part of the lawn, or part of the human face. Hence, the pixel values of the top, bottom, left, and right ones of error blocks can be calculated by interpolation, so as to obtain the value of a substitute pixel and treat the value of the substitute pixel as the value of the error pixel. However, sometimes the correlation between adjacent pixels is low; as a result, errors in the values calculated by interpolation are large, thereby compromising the quality of a repaired image. For information related to the spatial error concealment method, see the following literature: S. C. Huang and S. Y. Kuo, “Optimization of Spatial Error Concealment for H.264 Featuring Low Complexity,” Proceedings of the 14th International MultiMedia Modeling Conference (MMM'08), Kyoto, Japan, January 2008, which is incorporated herein by reference.

A temporal error concealment method involves finding appropriate motion vectors by making reference to a previous image for replacing lost or error motion vectors to repair an error block. Frequently seen temporal error concealment methods are, namely zero motion vector method and boundary matching. Zero motion vector method involves finding from a previous image a reference block corresponding in position to an error block and then replacing an error block in a current image with the reference block. Boundary matching involves searching for the most appropriate motion vectors using correct pixels at the boundaries of an error block. However, zero motion vector method has its own disadvantages, such as inaccuracy. Likewise, boundary matching has its own disadvantages, such as intricate computation. For information related to the temporal error concealment method, see the following literature: S. C. Huang and S. Y. Kuo, “Temporal Error Concealment for H.264 Using Optimum Regression Plane,” Proceedings of the 14th International MultiMedia Modeling Conference (MMM'08), Kyoto, Japan, January 2008, which is incorporated herein by reference. A mixed error concealment method entails using temporal and spatial error concealment methods to repair an error block.

The spatial, temporal, and mixed error concealment methods involve generating from the plurality of reference data a substitute data for replacing the error data. However, in case of a low correlation between parts of the reference data and the error data, the quality of a repaired image is likely to be compromised. In view of this, a method for filtering out a reference data can enhance the quality of an image.

### BRIEF SUMMARY OF THE INVENTION

It is an objective of the present invention to provide a method for repairing an image. To repair an image, the method applies a statistic method for filtering out reference data so as to enhance the quality of a repaired image.

In an embodiment of the present invention, a method for repairing an image is provided to generate a substitute data to replace an error data in an image. The method comprises the steps of:
(a) sampling a plurality of reference data associated with an error data;
(b) generating a predicted value range by a statistic method according to the plurality of reference data;
(c) generating a plurality of repairing data according to the predicted value range, wherein values of the plurality of repairing data are within the predicted value range; and
(d) generating a substitute data according to the plurality of repairing data.

### BRIEF DESCRIPTION OF THE SEVERAL VIEWS OF THE DRAWINGS

FIG. 1 is a flow chart of an image repairing method of the present invention;

FIG. 2 is a flow chart of a spatial error concealment method of the present invention;

FIG. 3 is a schematic view of the spatial error concealment method of the present invention;

FIG. 4 is a flow chart of a temporal error concealment method of the present invention; and

FIG. 5 is a schematic view of the temporal error concealment method of the present invention.

### DETAILED DESCRIPTION OF THE INVENTION

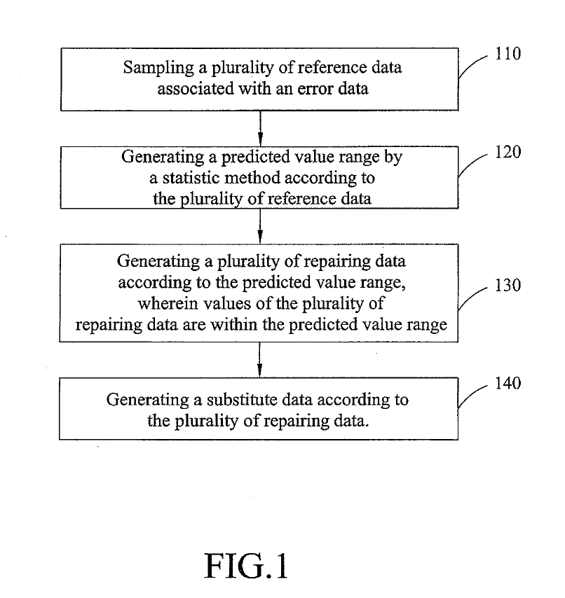

Referring to FIG. 1, there is shown a flow chart of an image repairing method of the present invention. First, in step 110, a plurality of reference data associated with an error data is sampled. The error data is one of pixel values of an error block to be repaired or a lost motion vector from the error block. The plurality of reference data are the data having correlation with the error data, such as the value of a pixel spatially adjacent to the error data, or the value of a motion vector temporally adjacent to the error data.

Step 120 involves generating a predicted value range by a statistic method according to the plurality of reference data. The predicted value range is used to filter out the plurality of reference data, so as to prevent the reference data of a low correlation from being used to repair the error data. Step 130 involves generating a plurality of repairing data according to the predicted value range, wherein values of the plurality of repairing data are within the predicted value range. Finally, step 140 involves generating a substitute data for replacing the error data according to the plurality of repairing data. The application of the method of the present invention in spatial and temporal error concealment methods is described below.

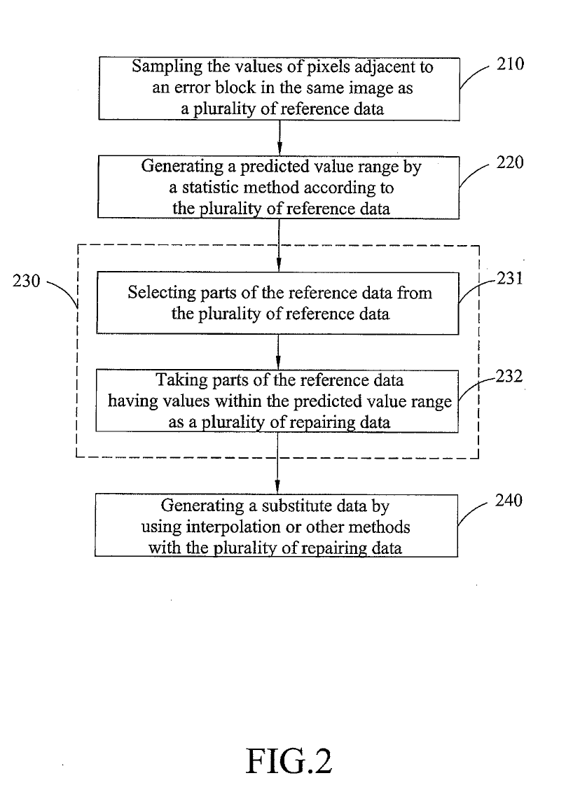

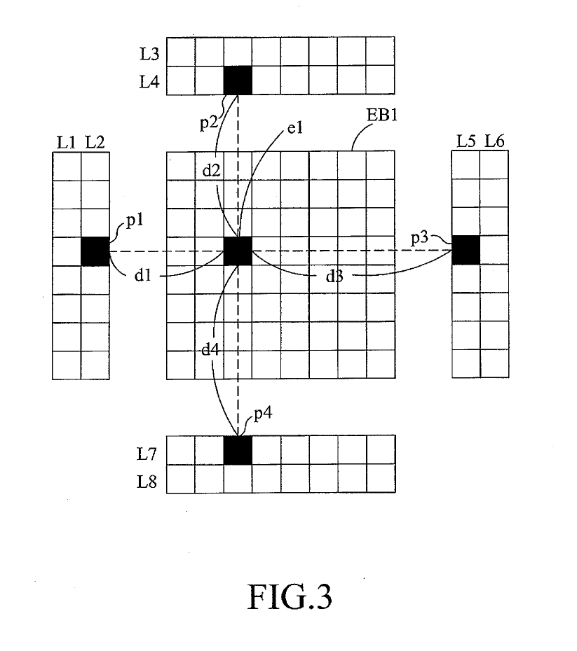

Referring to FIG. 2 and FIG. 3, there are shown a flow chart of a spatial error concealment method of the present invention and a schematic view of the spatial error concealment method of the present invention. When the image repairing method is applied to the spatial error concealment method, the plurality of reference data sampled in step 210 are the values of the pixels adjacent to an error block EB1 in the same image. For example, the values of two adjacent rows of pixels L1-L8 at the top, bottom, left and right of the error block EB1 are sampled to serve as the plurality of reference data, wherein pixels L1-L8 have a total of 64 pixels. In practice, pixels L1-L8 are immediately adjacent to the error block EB1. As shown in FIG. 3, pixels L1-L8 are slightly spaced apart from the error block EB1 so as to be marked conveniently.

Then, step 220 involves generating a predicted value range (V_{low}, V_{high}) of a pixel value by applying a statistic method of t distribution or normal distribution according to the values of pixels L1-L8. V_{low} denotes the minimum value of the predicted value range. V_{high} denotes the maximum value of the predicted value range. According to statistic principles, the predicted value range (V_{low}, V_{high}) covers any specific possible range of pixel values, for example, covering 95% of possible pixel values. Generating a predicted value range by applying a statistic method according to a specific number of samples is a prior art but is not a technical feature of the present invention, and thus it is not described in detail herein.

Step 230 corresponds to step 130 in FIG. 1. Step 230 includes sub-steps 231 and 232. Sub-step 231 involves selecting parts of the reference data from the plurality of reference data so as to select a pixel that has the highest correlation with error pixel e1, for example, selecting from pixels L1-L8 the values of pixels p1-p4 nearest to the top, bottom, left, and right of the error pixel e1 to be repaired. Sub-step 232 involves selecting the reference data (i.e., pixels p1-p4) having values within the predicted value range (V_{low}, V_{high}) from the parts selected in sub-step 231, and taking the reference data (i.e., pixels p1-p4) having values within the predicted value range (V_{low}, V_{high}) as the plurality of repairing data. Assuming that, in an embodiment, the value of pixel p1 is less than the minimum value V_{low}, it is necessary to remove the value of pixel p1 and keep the values of the remaining three pixels p2-p4 as the plurality of repairing data.

Finally, in step 240, the spatial error concealment method involves generating a substitute data for replacing the value of the error pixel using conventional interpolation or other methods with the plurality of repairing data (that is, taking the values of pixels). For example, in the aforesaid embodiment, with pixel p1 being removed, a pixel value for replacing error pixel e1 is generated by interpolation, using the remaining three pixels p2-p4. Several known ways of interpolation are described as follows:

(1) where four pixel values fall within the predicted value range (V_{low, V}_{high}), such as pixels p1-p4 that fall within such range as:

$$repairing data = ( \frac{p 1 * d 3 + p 3 * d 1}{d 3 + d 1} + \frac{p 2 * d 4 + p 4 * d 2}{d 4 + d 2} ) / 2 ,$$

where d1-d4 denote the distances between pixels p1-p4 and error pixel e1.

(2) where three pixel values fall within the predicted value range (V_{low}, V_{high}), such as pixels p2-p4 that fall within such range as:

$$repairing data = ( p 3 + \frac{p 2 * d 4 + p 4 * d 2}{d 4 + d 2} ) / 2$$

(3) where two pixel values fall within the predicted value range (V_{low}, V_{high}), such as pixels p2, p4 that fall within such range as:

repairing data=(p2+p4)/2

(4) where one pixel value falls within the predicted value range (V_{low}, V_{high}), such as pixel p2 that falls within such range as:

repairing data=p2

Also, where none of the values of the four pixels p1-p4 falls within the predicted value range (V_{low}, V_{high}), it is, in an embodiment of the present invention, feasible to treat the average of the maximum value V_{high} and the minimum value V_{low} of the predicted value range as a repairing data:

repairing data=(V_{low}+V_{high})/2

In so doing, by applying the image repairing method of the present invention to a spatial error concealment method, reference data of low correlation can be filtered out to enhance the quality of a repaired image.

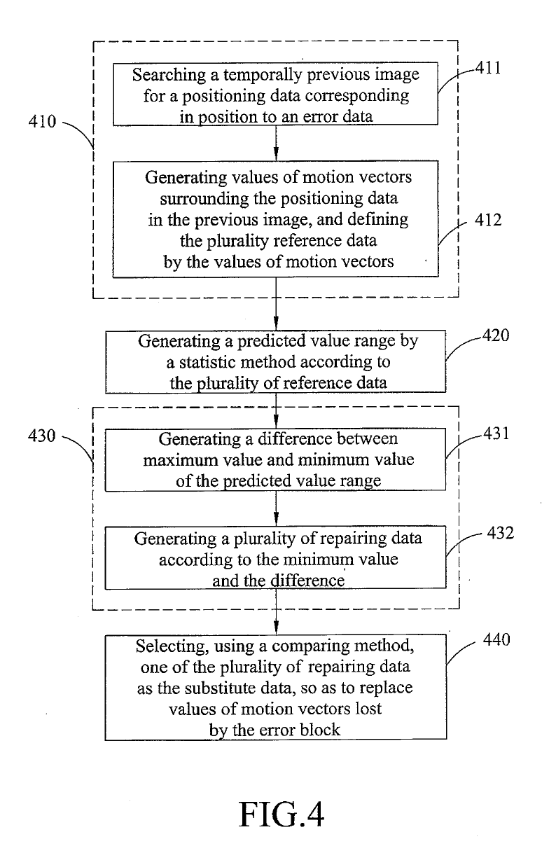

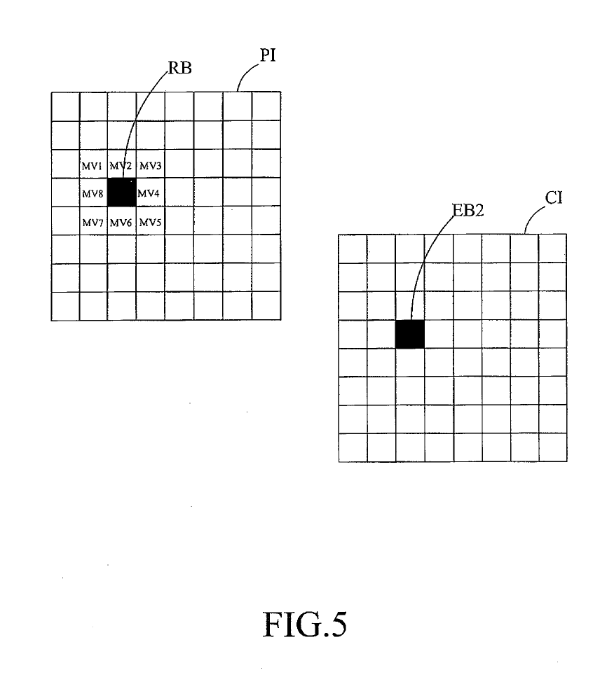

Referring to FIG. 4 and FIG. 5, there are shown a flow chart of a temporal error concealment method of the present invention and a schematic view of the temporal error concealment method of the present invention. Step 410 shown in FIG. 4 corresponds to step 110 shown in FIG. 1. Step 410 includes sub-steps 411 and 412, when the present invention is applied to the temporal error concealment method. Sub-step 411 involves searching a temporally previous image PI for a positioning data corresponding in position to the error data. In the temporal error concealment method, the error data means the value of a motion vector lost by an error block EB2 in a current image CI, and the positioning data means a block RB in a previous image PI, and the location of the block RB corresponds to the location of the error block EB2 in the image CI. Sub-step 412 involves generating values of motion vectors surrounding the positioning data in the previous image, and defining the plurality reference data by the values of motion vectors. The plurality of reference data are values of motion vectors MV1-MV8 of the blocks located at the top left, the top, the top right, the right, the bottom right, the bottom, the bottom left, and the left of the positioning data (that is, the block RB).

In step 420, a predicted value range is generated by applying a statistic method, such as t distribution or normal distribution, using the values of the plurality of motion vectors MV1-MV8. Since a motion vector has x component and y component, and thus it is feasible to generate the predicted value range (XV_{low}, XV_{high}) of x component and the predicted value range (YV_{low}, YV_{high}) of y component according to the values of the plurality of motion vectors MV1-MV8. Generating a predicted value range by applying a statistic method according to a specific number of samples is a prior art but is not a technical feature of the present invention, and thus it is not described in detail herein.

Step 430 corresponds to step 130 in FIG. 1. Step 430 includes sub-steps 431 and 432. Taking the generation of x component as an example, in step 431, a difference XD between the maximum value XV_{high} and the minimum value XV_{low} of the predicted value range of x component is generated. Then, in step 432, a plurality of x component repairing data is generated according to the minimum value XV_{low} and the difference XD. In an embodiment of the present invention, the x component repairing data is defined by XV_{low}+0.5*kx, where 0≦kx≦2*XD, and kx is an integer. As indicated by the aforesaid formula, the value of kx ranges between 0 and 2*XD, and a plurality of x component repairing data equals the sum of the minimum value XV_{low} and 0.5*kx. For example, assuming, in an embodiment:
predicted value range (XV_{low}=1, XV_{high}=4) of x component;
difference XD=4−1=3;
0≦kx≦2*XD, where 0≦kx≦6, and kx is an integer;
x component repairing data=XV_{low}+0.5*kx, where kx=0, 1, 2, 3, 4, 5, 6;
x component repairing data=1+0.5*0; 1+0.5*1; 1+0.5*2; 1+0.5*3; 1+0.5*4; 1+0.5*5; 1+0.5*6;

Eventually generated is:
x component repairing data=1, 1.5, 2, 2.5, 3, 3.5, 4

Likewise, step 430 also involves generating a plurality of y component repairing data by applying the predicted value range (YV_{low}, YV_{high}) of y component.

Finally, step 440 involves selecting, using a comparing method, one x component repairing data and one y component repairing data as the substitute data, so as to replace values of motion vectors lost by the error block EB2. In an embodiment of the present invention, the comparing method may use a known boundary match algorithm or other comparing methods. For example, the plurality of x component repairing data combines with y component repairing data to form a plurality of motion vectors for selection. The boundary match algorithm finds boundary pixel values in a previous image PI according to the motion vectors, respectively, and calculates the total square difference between each boundary pixel value and the boundary pixel value adjacent to the error block EB2. Finally, the boundary match algorithm selects motion vectors having the total of the least square differences to replace motion vectors lost by the error block EB2. The boundary match algorithm or another comparing method is not a technical feature of the present invention and thus is not described in detail herein.

As revealed in the above description, the image repairing method of the present invention involves generating a predicted value range by a statistic method according to a plurality of sampled reference data of correlation, and then taking the reference data having values within the predicted value range as a repairing data, so as to enhance the quality of a repaired image.

The foregoing preferred embodiments are provided to illustrate the present invention and are not intended to be restrictive of the scope of the present invention. Hence, all equivalent modifications and variations made to the foregoing embodiments without departing from the spirit embodied in the disclosure of the present invention should fall within the appended claims of the present invention.

What is claimed is:

1. An image repairing method for generating a substitute data to replace an error data in an image within a video, said method comprising the steps of:
(a) from said video sampling a plurality of reference data associated with said error data;
(b) generating a predicted value range by a statistic method according to said plurality of reference data;
(c) generating a plurality of repairing data according to said predicted value range, wherein values of said plurality of repairing data are within said predicted value range; and
(d) generating said substitute data according to said plurality of repairing data.

2. The method according to claim 1, wherein said plurality of reference data associated with said error data are spatially adjacent to said error data.

3. The method according to claim 2, wherein said step (c) comprises:
(c1) selecting parts of said plurality of reference data; and
(c2) further selecting reference data having values within said predicted value range from said parts selected in step (c1), and taking said reference data having values within said predicted value range as said plurality of repairing data.

4. The method according to claim 2, wherein said plurality of reference data spatially surround said error data.

5. The method according to claim 4, wherein locations of said plurality of reference data are at the top, bottom, left, and right of a location of said error data.

6. The method according to claim 4, wherein said plurality of reference data are pixel values.

7. The method according to claim 1, wherein said step (b) generates said predicted value range by applying said statistic method of t distribution or normal distribution.

8. The method according to claim 1, wherein said step (d) generates said substitute data using interpolation with said plurality of repairing data.

9. The method according to claim 1, wherein said plurality of reference data associated with said error data are temporally adjacent to said error data.

10. The method according to claim 9, wherein said step (a) comprises:
(a1) searching a temporally previous image for a positioning data corresponding in position to said error data; and
(a2) generating values of motion vectors surrounding said positioning data in said previous image, and defining said plurality reference data by said values of motion vectors.

11. The method according to claim 10, wherein locations of said plurality of reference data are at the top left, top, top right, right, bottom right, bottom, bottom left, and left of a location of said positioning data.

12. The method according to claim 9, wherein said step (b) generates said predicted value range by applying said statistic method of t distribution or normal distribution.

13. The method according to claim 9, wherein said step (c) comprises:
(c3) generating a difference between maximum value and minimum value of said predicted value range; and
(c4) generating said plurality of repairing data according to said minimum value and said difference.

14. The method according to claim 9, wherein said step (d) further compares pixel values to select one of said plurality of repairing data as said substitute data.

15. The method according to claim 14, wherein said comparing method uses boundary match algorithm.
